(19) United States
(12) Patent Application Publication
(10) Pub. No.: US 2026/0031475 A1
(43) Pub. Date: Jan. 29, 2026

(54) BATTERY CASE, BATTERY CELL, AND BATTERY ARRANGEMENT

(71) Applicant: PowerCo SE, Salzgitter (DE)

(72) Inventors: Sebastian KRAAS, Wolfenbuettel (DE); Zhihang YU, Lengende (DE)

(73) Assignee: PowerCo SE, Salzgitter (DE)

(21) Appl. No.: 19/279,414

(22) Filed: Jul. 24, 2025

(30) Foreign Application Priority Data
Jul. 24, 2024 (DE) 10 2024 206 942.6

(51) Int. Cl. H01M 50/367; H01M 50/107; H01M 50/119; H01M 50/121; H01M 50/122; H01M 50/213

(52) U.S. Cl. CPC H01M 50/367; H01M 50/119; H01M 50/121; H01M 50/122; H01M 50/107; H01M 50/213

(57) ABSTRACT

A battery case for a battery cell. The battery case includes a base body that encloses, at least in areas. A chamber for accommodating galvanic components. A plurality of ventilation openings that connect the chamber to the surroundings of the base body. A plurality of ventilation lines that extend on an inner side of the base body facing the chamber and that are fluidically coupled to at least a portion of the plurality of ventilation openings. The plurality of ventilation lines extending in a material that forms the base body. A battery cell with such a battery case and a battery arrangement are also provided.

This nonprovisional application claims priority under 35 U.S.C. § 119(a) to German Patent Application No. DE 10 2024 206 942.6, which was filed in Germany on Jul. 24, 2024, and which is herein incorporated by reference.

### FIELD OF THE INVENTION

The present invention relates to a battery case, a battery cell, and a battery arrangement according to the appended claims.

### DESCRIPTION OF THE BACKGROUND ART

Battery arrangements generally comprise multiple battery cells, each of which includes a battery case that is filled with battery components such as an electrolyte and electrodes.

Under extreme thermal stress, for example in a test setup for testing the thermal stability of a battery arrangement, situations may arise in which gases that form inside a particular battery cell must be discharged to the surroundings to prevent an explosion of the battery cell.

For discharging gases from a battery cell into the surroundings, ventilation openings are known which are introduced into the battery case. However, under extreme thermal stress, local pressure maxima may result in damage to the battery case.

DE 10 2023 115 240 A1 describes a degassing unit for an electronics housing.

DE 10 2022 107 931 A1, which corresponds to US 2023/0327276, describes a battery arrangement with battery cells, each of which has a ventilation opening and a degassing channel that overlays the ventilation opening.

WO 2021/204474 A1, which corresponds to US 2023/0056487, describes a battery for a motor vehicle, comprising a cell assembly with a plurality of battery cells. The battery cells are situated in a battery housing that includes a degassing element and a receiving space for accommodating gas escaping from respective battery cells.

### SUMMARY OF THE INVENTION

It is therefore an object of the present invention to provide a battery case that is mechanically stable, even under extreme thermal stress.

In an example, the object is achieved by a battery case, a battery cell, and a battery. Features and details that are described in conjunction with the battery case according to the invention naturally also apply in conjunction with the battery cell according to the invention and the battery arrangement according to the invention, and vice versa in each case, so that with regard to the disclosure of the individual aspects of the invention, reciprocal reference is always possible.

Thus, according to a first aspect of the present invention a battery case for a battery cell is provided.

The provided battery case includes a base body that encloses, at least in areas, a chamber for accommodating galvanic components, a plurality of ventilation openings that connect the chamber to the surroundings of the base body, and a plurality of ventilation lines that extend on an inner side of the base body facing the chamber and that are fluidically coupled to at least a portion of the plurality of ventilation openings, wherein the plurality of ventilation lines extend in a material that forms the base body.

The provided battery case is based on ventilation lines that are introduced into a material that forms a base body for accommodating galvanic components such as an electrolyte and electrodes. This means that the ventilation lines are not formed by a multilayer structure, but, rather, extend directly in the material that forms the base body.

The ventilation lines are open toward a chamber that is formed or enclosed by the base body, i.e., are open toward an electrolyte side, in particular along its entire course, so that the ventilation lines can discharge fluid, in particular gas, that arises in the chamber to the plurality of ventilation openings, and lastly into the surroundings.

Due to the fluidic coupling, provided according to the invention, of the plurality of ventilation lines to the plurality of ventilation openings, for example for the case that galvanic components within a particular battery cell melt and form fluid inclusions, in particular gas inclusions, discharge of fluid via the ventilation lines to respective ventilation openings is also made possible. Furthermore, the plurality of ventilation lines brings about the discharge of fluids from the entire chamber, so that local pressure maxima and resulting deformations of the base body are avoided.

The base body of the provided battery case may be a cylinder or a tube, for example. In particular, the ventilation lines extend in the material forming the base body in such a way that the material forms an essentially flat surface, in which indentations in the shape of the ventilation lines are formed.

Various ventilation lines may have the same cross section or the same length, or may have different cross sections or different lengths.

It may be provided that the plurality of ventilation lines is molded or introduced into the material that forms the base body.

For example, it may be provided that the plurality of ventilation lines is introduced into the base body by material removal and/or deformation of the material. For this purpose the ventilation lines may, for example, be milled, stamped, pressed, embossed, and/or burned in, in particular lasered in.

The ventilation lines may be introduced into the base body in a process following the shaping of the base body, or during shaping of the base body may initially be provided in same, for example during a casting or stamping process.

It may be further provided that respective ventilation lines extend at least up to one end of the battery case.

As the result of ventilation lines that extend at least up to one end of the battery, in particular fluid that is concentrated at the base may be discharged to a respective ventilation opening.

It may be further provided that the plurality of ventilation lines is provided at a longitudinal side of the battery case.

Ventilation lines that are provided along the longitudinal side, in particular in combination with ventilation openings provided along the longitudinal side, have proven to be particularly suitable for preventing an explosion of a battery cell under extreme thermal stress.

It may be further provided that the battery case includes a plurality of ventilation lines, at least a portion of the ventilation lines extending in parallel to a longitudinal axis of the battery case.

Ventilation lines extending in parallel to a longitudinal axis, in particular an axis of symmetry of the battery case, require rapid discharge of fluids to respective ventilation openings, thus avoiding local pressure maxima.

It may be further provided that the battery case includes a plurality of ventilation lines, at least a portion of the ventilation lines extending at an angle between 1° and 89° with respect to a longitudinal axis of the battery case, wherein the angles differ among various ventilation lines.

Ventilation lines provided at various angles with respect to a particular longitudinal axis of the battery case allow highly diversified discharge of a large gas volume to respective ventilation openings, so that fluid that has randomly formed in the chamber can always access a ventilation line.

It may be provided that the angles of the ventilation lines, i.e., the magnitude of the angles, may increase in the direction away from the longitudinal axis.

Angles of the ventilation lines which increase in the direction away from the longitudinal axis may be designed in a star-shaped pattern, for example.

It may be provided, for example, that the plurality of ventilation lines includes circular, triangular, quadrangular, or polygonal ventilation lines.

In particular, circular or oval ventilation lines have proven to be particularly suitable for discharging large gas volumes.

It may be further provided that the battery case is made of at least one material from the following list of materials: steel, aluminum, metal alloy, polymer material, composite material.

According to a second aspect, the present invention relates to a battery cell for providing electrical energy, wherein the battery cell includes an example of the provided battery case and galvanic components situated in the battery case.

As a result of the provided battery case, the provided battery cell is particularly robust against extreme thermal stress.

According to a third aspect, the present invention relates to a battery arrangement for providing electrical energy, wherein the battery arrangement includes a plurality of examples of the provided battery cell.

As a result of the provided battery case or battery cell, the provided arrangement is particularly robust against extreme thermal stress. In particular, the provided battery case or battery cell minimizes the likelihood of an explosion of the battery cell and a resulting chain reaction due to an exploding battery cell in the battery arrangement, as well as mechanical and thermal stress on further battery cells of the battery arrangement during extreme thermal stress on an individual battery cell of the battery arrangement. Such extreme thermal stress may be, for example, a so-called “thermal runaway,” in particular during testing of the behavior of a battery arrangement during a thermal runaway of individual cells.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a battery case,

FIG. 2 shows an example of a battery case,

FIG. 3 shows an example of a battery case,

FIG. 4 shows an example of a battery case,

FIG. 5 shows a cross section of an example of the provided battery case, and

FIG. 6 shows an example of the provided battery arrangement with a plurality of possible examples of the provided battery cell.

### DETAILED DESCRIPTION

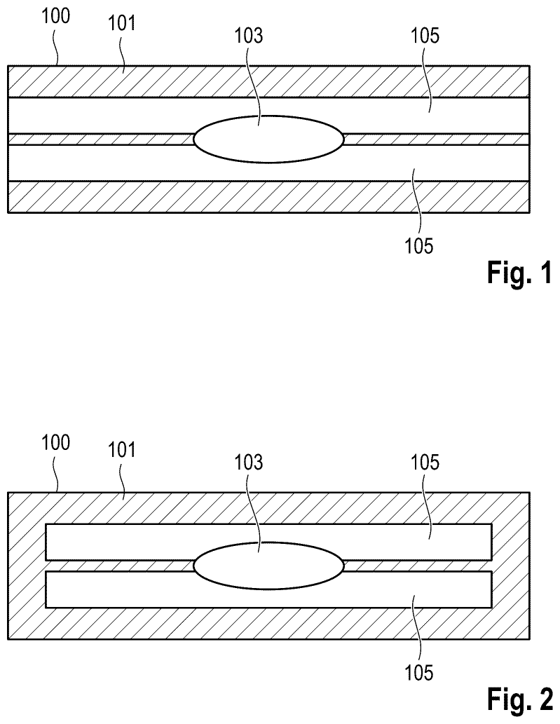

FIG. 1 illustrates a battery case 100 for a battery cell.

The battery case 100 includes a base body 101 that encloses, at least in areas, a chamber for accommodating galvanic components, a ventilation opening 103 that connects the chamber to the surroundings of the base body 101, and ventilation lines 105 that extend on an inner side of the base body 101 facing the chamber and that are fluidically coupled to the ventilation opening 103. The ventilation lines 105 extend in a material that forms the base body 101 or are introduced into the material of the base body 101, so that in its edge region the ventilation opening 103 opens or merges into the ventilation lines 105.

In FIG. 1 the ventilation lines 105 extend over the entire length of the base body 101, so that gas that is released in the chamber is discharged along the entire length of the battery case 100 and to the ventilation opening 103.

In FIG. 2 the ventilation lines have a smaller design than in FIG. 1, so that edge regions of the battery case 100, at which components which do not evolve gases are generally situated, are not contacted by the ventilation lines.

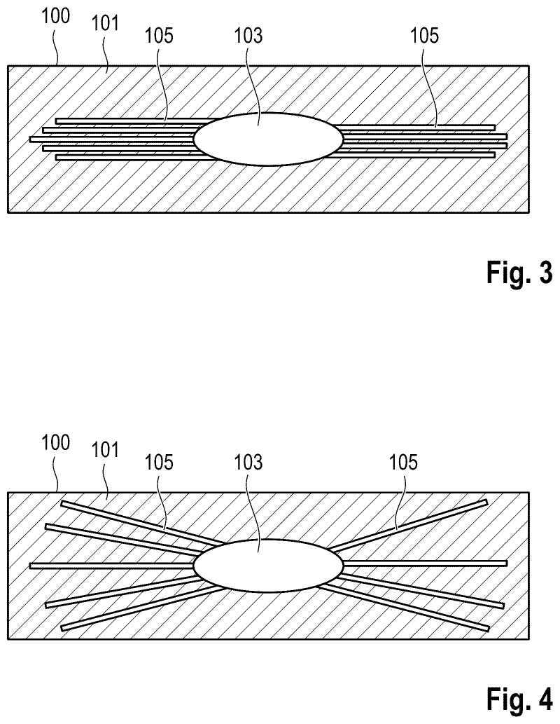

In FIG. 3 the ventilation lines 105 are narrower than in FIGS. 1 and 2 but are more numerous, so that a particularly large area for discharging fluid is covered by the ventilation lines 105.

In FIG. 4 the ventilation lines 105 are distributed in a star-shaped pattern at a changing angle with respect to a longitudinal axis of the battery case 100, so that a particularly large area for discharging fluid is likewise covered by the ventilation lines 105.

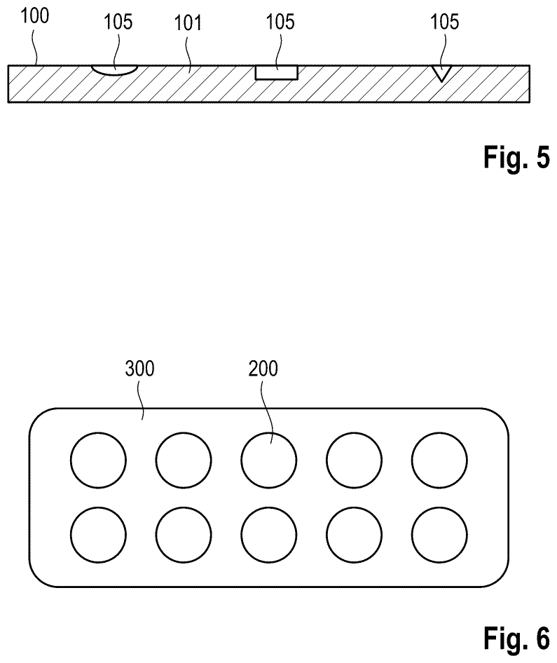

FIG. 5 illustrates a cross section of an example of the provided battery case 110 with a chamber 107. Various cross sections or shapes of the ventilation lines 105 are apparent here, namely, a circular shape, a quadrangular or cuboidal shape, and a triangular shape. It is also clearly apparent that the ventilation lines 105 extend flatly with respect to a surface of the base body 101 or are introduced into the base body 101.

FIG. 6 illustrates a battery arrangement 300 comprising a plurality of battery cells 200, each of which is formed by battery cases 100 according to FIGS. 1 through 5.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A battery case for a battery cell, the battery case comprising:
a base body that encloses, at least in areas, a chamber for accommodating galvanic components;
at least two ventilation openings that connect the chamber to the surroundings of the base body; and
at least two ventilation lines that extend on an inner side of the base body facing the chamber and that are fluidically coupled to at least a portion of the at least two ventilation openings, the at least two ventilation lines extending in a material that forms the base body.

2. The battery case according to claim 1, wherein the at least two ventilation lines is molded or introduced into the material that forms the base body.

3. The battery case according to claim 1, wherein respective ventilation lines extend up to an end of the battery case.

4. The battery case according to claim 1, wherein the at least two ventilation lines are provided at a longitudinal side of the battery case.

5. The battery case according to claim 1, wherein at least a portion of the at least two ventilation lines extend in parallel to a longitudinal axis of the battery case.

6. The battery case according to claim 1, wherein at least a portion of the at least two ventilation lines extend at an angle between 1° and 89° with respect to a longitudinal axis of the battery case, and wherein the angles differ among the ventilation lines.

7. The battery case according to claim 6, wherein the angles of the at least two ventilation lines increase in a direction away from the longitudinal axis.

8. The battery case according to claim 1, wherein the at least two ventilation lines include circular, triangular, quadrangular, or polygonal ventilation lines.

9. The battery case according to claim 1, wherein the battery case is made of: steel, aluminum, metal alloy, polymer material, and/or composite material.

10. A battery cell to provide electrical energy, wherein the battery cell comprises:
the battery case according to claim 1; and
galvanic components arranged in the battery case.

11. A battery arrangement to provide electrical energy, wherein the battery arrangement comprises a plurality of battery cells according to claim 10.
